(19) United States
(12) Patent Application Publication
(10) Pub. No.: US 2005/0267790 A1
(43) Pub. Date: Dec. 1, 2005

(54) System and method for applying and verifying a retrievable quality mark for foods and raw materials thereof

(76) Inventor: Yitzchak Skalsky, Nitzan. M P Evtach (IL)

Correspondence Address: DANIEL J SWIRSKY, PO BOX 2345, BEIT SHEMESH, 99544, IL

(21) Appl. No.: 10/972,329

(22) Filed: Oct. 26, 2004

(30) Foreign Application Priority Data
May 31, 2004 (IL) IL 162262

(51) Int. Cl. G06F 17/60

(52) U.S. Cl. 705/7

(57) ABSTRACT

Retrievable quality assurance certifying means are associated with products by providing a plurality of specification records characterizing a product's quality profile, compiling a plurality of standard records comprising predetermined parameters adapted to characterize said product's quality standard by a commercially independent Quality Assurance Authority, logging a predetermined set of parameters in a plurality of documentation records, storing the specification, standard and documentation records in a central product quality database, and, wherein all the logged parameters are found tolerated within the product's quality standard adapted by the Quality Assurance Authority, associating the product or the product's package with a retrievable quality assurance certifying means. The product's quality assurance verification is further established through a unique identifier associated with said certifying means to enable traceability of the product and it's ingredients/production process.

### FIELD OF THE INVENTION

The present invention relates to a retrievable quality assurance certifying means for products, and a system and method thereof.

### BACKGROUND OF THE INVENTION

In all industrial countries and in some developing countries as well, it is rare that a household self-produces its own food, clothing, furniture and tools; rather, purchasing these items from a plurality of suppliers commercializing them is more common and conforms the modern way of life. Becoming thus a consumer rather than a producer is both convenient and simplifies household maintenance. However, this arrangement suffers from one major disadvantage; the consumer, being cut off from the production process and the procedures involved therein, specifically, the manufacture, packaging, shipment, distribution and storage processes, cannot witness any of those processes, control them or supervise them, and moreover, cannot verify the soundness of those processes, e.g. checking compliance with Good Manufacture Practice (GMP) regulations, and also cannot access analysis results or production parameters etc., the consumer is thus captivated in the manufacturer's/supplier's declarations regarding the product, usually provided by means of a quality label or any other acceptable indication means, attached to the product or to it's package.

U.S. Pat. Application 20030236768 to Sribhibhadh et al. discloses a supply chain management system and method for food manufacture and ingredients tracing and tracking including an application program comprising of components for storing farming, quality parameters, production procedures or shipping information for a product's batch and another component for retrieving the information stored, wherein deletion, alteration, and addition of various fields for entering relevant information included in said components is capable of being performed in real or near real-time, thus, allowing companies that operate within the supply-chain management system to exchange information bi-directionally throughout the entire system.

U.S. Pat. Application 20040098282 to Levy et al. teaches a method for food quality certifying wherein unique identifiers are defined with respect to products and/or ingredients. Each identifier is indicative of a source of information regarding a certification of the respective food ingredient with respect to a particular food quality. The information is stored in a computer database. Unique identifiers for various ingredients are provided to a certification agency associated with the manufacturer, the certification agency associated with the manufacturer being non-identical to the certification agencies certifying the food qualities of the various ingredients. Information is retrieved, by using the identifiers regarding the certification of the ingredients. The certification agency associated with the manufacturer is then able to certify the food quality of the product based in part on the retrieved information.

A cost effective, retrievable quality assurance certifying means for products and a quality management system and method thereof useful for ensuring a product's compliance with a declared quality profile and/or quality standard, wherein said system and means are further adapted to enable retrieval of any production related information, are thus a long felt need.

### SUMMARY OF THE INVENTION

It is an objective of the present invention to provide a method as well as system for applying and verifying a cost effective, retrievable quality assurance certifying means for products, so that a consumer purchasing a product certified in accordance with the present invention is thus able to trust the product's quality profile to be in accordance with declared product's profile stated by a manufacturer/supplier.

It is yet another objective of the invention to ensure product's quality by means of devising custom-tailored quality standard for a given product, record-keeping and monitoring any of its production steps and related information, and to further enable retrieval of each of the involved parameters and/or recorded data, thus allowing a consumer, or any other interested party, such as health organizations or segments of the industry not represented by the manufacturer/supplier, to track and trace any portion of a product's certification process, and to further corroborate the soundness of the production process and the product's compliance with the predetermined product's quality standard.

It is the core of the present invention to establish a method for applying a retrievable quality assurance certifying means for products obtained in a process according thereto, comprising the steps of: providing a plurality of specification records characterizing said product's quality profile by means of at least one originator commercializing said product; storing said specification records in a central product quality database; compiling a plurality of standard records comprising predetermined parameters adapted to characterize said product's quality standard by a commercially independent Quality Assurance Authority; each of said parameters is having at least one quality scale including a permitted range and at least one forbidden range, such that appropriate quantitative measures of said product's quality are provided; storing said standard records in said central product quality database; logging a predetermined set of parameters in a plurality of documentation records wherein at least a portion of said parameters is selected from the parameters contained in said standard records; storing said documentation records in said central product quality database; and, wherein all the logged parameters are found tolerated within the product's quality standard adapted by the Quality Assurance Authority, associating the product or the product's package with a retrievable quality assurance certifying means.

The present invention further relates to a system for a retrievable quality assurance certifying means for products, especially useful for product's quality management, comprising at least one product; said product's quality profile is characterized by a plurality of specification records; at least one originator commercializing said product; a commercially independent Quality Assurance Authority adapted for compiling a plurality of standard records comprising predetermined parameters adapted to characterize said product's quality standard; each of said parameters is having at least one quality scale including a permitted range and at least one forbidden range, such that appropriate quantitative measures of said product's quality are provided; means for logging a predetermined set of parameters in a plurality of documentation records, wherein at least a portion of said parameters is selected from the parameters contained in said standard records; a central product quality database adapted for storage of said specification, standard or documentation records; and, a retrievable quality assurance certifying means, associated with said product or said product's package, wherein all the logged parameters are found tolerated within the product's quality standard adapted by the Quality Assurance Authority.

### BRIEF DESCRIPTION OF THE DRAWINGS

In order to understand the invention and to see how it may be implemented in practice, several preferred embodiments will now be described, by way of non-limiting example only, with reference to the accompanying drawing, in which:

FIG. 1 is a block diagram presenting a schematic and generalized illustration of the present system for applying and verifying retrievable quality assurance certifying means for various products;

FIG. 2a is a block diagram presenting a schematic generalized illustration of the present system, in accordance with the prior art, comprising a consumer, a supplier and a product characterized by a quality label;

FIG. 2b is a block diagram presenting a schematic generalized illustration of (a portion of) the present system in accordance with one embodiment of the present invention, comprising a consumer, a supplier and a product characterized by a quality label, certified by a retrievable quality assurance certifying means provided by means of a commercially independent Quality Assurance Authority;

FIG. 3 presents a flow chart (10) schematically illustrating a generalization of a suggested method for applying a retrievable quality assurance certifying means, in accordance with the present invention, detailing several further embodiments;

FIG. 4 presents a schematic illustration of data gleaning in accordance with yet another embodiment of the invention;

FIG. 5 presents a flow chart (30) schematically illustrating a generalization of the various steps of data source verification in accordance with one embodiment of the invention; and,

FIG. 6 presents a block diagram schematically illustrating an example of said product quality management system (50) in accordance with another embodiment of the invention.

### DETAILED DESCRIPTION OF THE INVENTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a retrievable quality assurance certifying means for products, and a system and method thereof.

The term ‘product’ in the context of the present invention relates any kind of goods or services, specifically, wherein said goods are either commodities selected from food; beverages; raw materials; organic compositions; or by-products thereof; or specialties selected from drugs or medications; dietary supplements; vitamins; minerals; amino acids; salts; carbohydrates; proteins; fats; cosmetics; perfumes; soaps; chemical preparations; or by-products thereof.

In the context of the present invention, the term ‘quality label’ refers generally to any kind of description pertaining to a product and provided either orally or in written form; specifically, the term refers to a mark, tag or any other indication means attached to a product or to a product's package, and adapted to either validate or specify a type of information characterizing said product, selected in a non-limiting manner from said product specification; said product attributes; listed ingredients or components existing in said product; listed ingredients or components absent from said product; production, preparation or manufacture attributes; packing attributes; shipping attributes; storage attributes; marketing attributes; or any combination thereof.

In the context of the present invention, the term ‘logging’ refers to the action of documenting, record-keeping, monitoring or updating, either in oral or in a written form, certain details, information or description of either a process, a progression, a step or a sequence of steps within a process, or any course of actions, events or occurrences, in a diary-like, logbook-like manner.

In the context of the present invention, the terms ‘originator’ and ‘supplier’, utilized hereinafter interchangeably, refer to one or more of the groups of farmers, growers, breeders, middlemen, manufacturers, pack houses, exporters, logistic providers, importers, distributors, retailers, or any other role-occupiers or entities along a supply chain and prior to its final destination, i.e. an end-user, also referred to herewith as a ‘consumer’ or ‘customer’.

The term ‘Quality Assurance Authority’ (QAA) refers in the context of the present invention to an expert group or organization, empowered by law or other jurisdiction, either international or regional, to issue and approve standards and/or regulations pertaining a predetermined field of expertise, e.g. electronics, motors, agriculture, textile, etc. Optionally, the Quality Assurance Authority is further adapted to conduct tests in order to verify that said standards are met in a given object, which said standards are pertinent thereto:

The term ‘standard’ in the context of the present invention relates to any previous documented experience concerning the product, preferably approved by an authorizing entity, e.g. a Quality Assurance Authority, health organization etc. Three level categories are considered, from the highest to lowest: (i) an approved and valid standard, e.g. US federal standard, European standard, Codex Elementarius, public health regulations; (ii) an approved and invalid or outdated standard, e.g. Swedish or German standard; (iii) an unapproved yet acceptable standard, for example, many years on-going tradition of whiskey distillation.

As an example, a standard for an industrial product such as baby feed formula, such as Materna™ dry milk powder, consists of ingredients, including: raw materials, quantities, expiry, presence of contaminators, water activity level; preparation procedures, including: critical thresholds/limits; chemical, physical and biological analysis of the product and by-products, contaminators' rate and various failure points, proper product's packaging and shelf life period of the product; storage conditions, including: temperature, humidity, drainage conditions, illumination; characteristics, such as: recommended dosage; listed nutritional values, such as: vitamins, minerals, salts, carbohydrates etc. per recommended dosage and their relative percentages from the recommended daily intake, etc.

As another example, a standard for an agricultural produce consists of: crops' type; soil type; soil quality; presence of contaminators in the relevant soil or water; contaminators' type (e.g. fertilizers, heavy metals, nitrates and nitrites, pesticides, mycotoxins etc.); time of seeding or planting; planting density; seed quality and seed treatment; agricultural activities performed on the soil including: seeding or planting, cultivating, spraying, fertilizing, watering; spraying policies including: time of treatment, repeatability of treatment, chemical/substance type, application rate, pest type, treatment purpose, harvest interval, next permitted harvest, spraying type, e.g. soil, foliage, roots, fruits etc., maximum acceptable limit, maximum residue limit, both according to specific updated official regulations (USA, EU etc.), if possible.

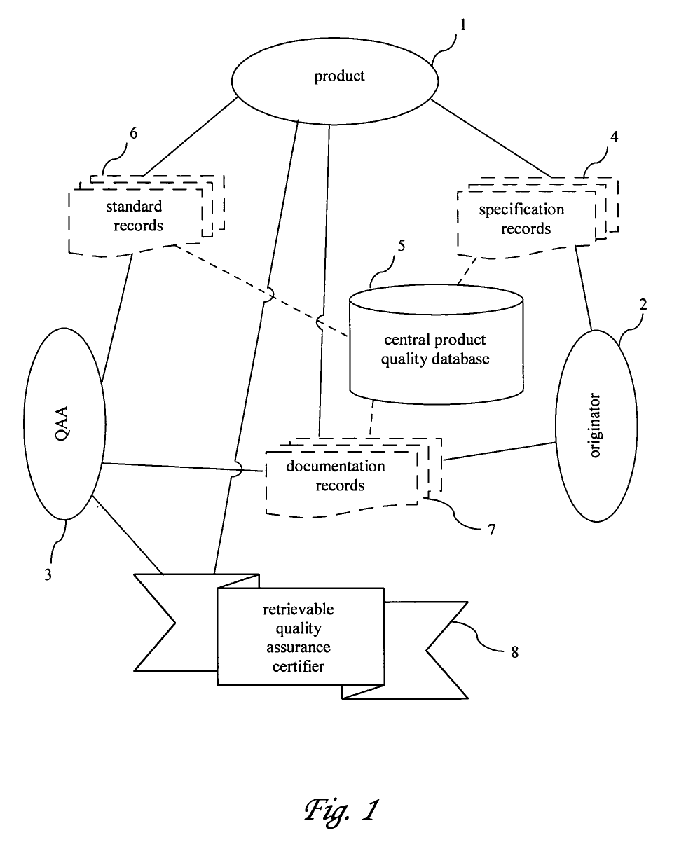

Reference is thus made now to FIG. 1, presenting a schematic and generalized illustration of the system intended for applying a retrievable quality assurance certifying means for products in accordance with the present invention, comprising at least one product (1); said product's quality profile is characterized by a plurality of specification records (4); at least one originator (2) commercializing said product (1); a commercially independent Quality Assurance Authority (3) adapted for compiling a plurality of standard records (6) comprising predetermined parameters adapted to characterize said product's quality standard; means for logging a predetermined set of parameters in a plurality of documentation records (7), wherein at least a portion of said parameters is selected from the parameters contained in said standard records (6); a central product quality database (5) adapted for storage of said specification, standard or documentation records (4), (6) & (7); and, a retrievable quality assurance certifying means (8), associated with said product (1) or said product's package, wherein all the parameters logged in said documentation records (7) are found tolerated within the product's quality standard as according to said standard records (6) by the Quality Assurance Authority (3).

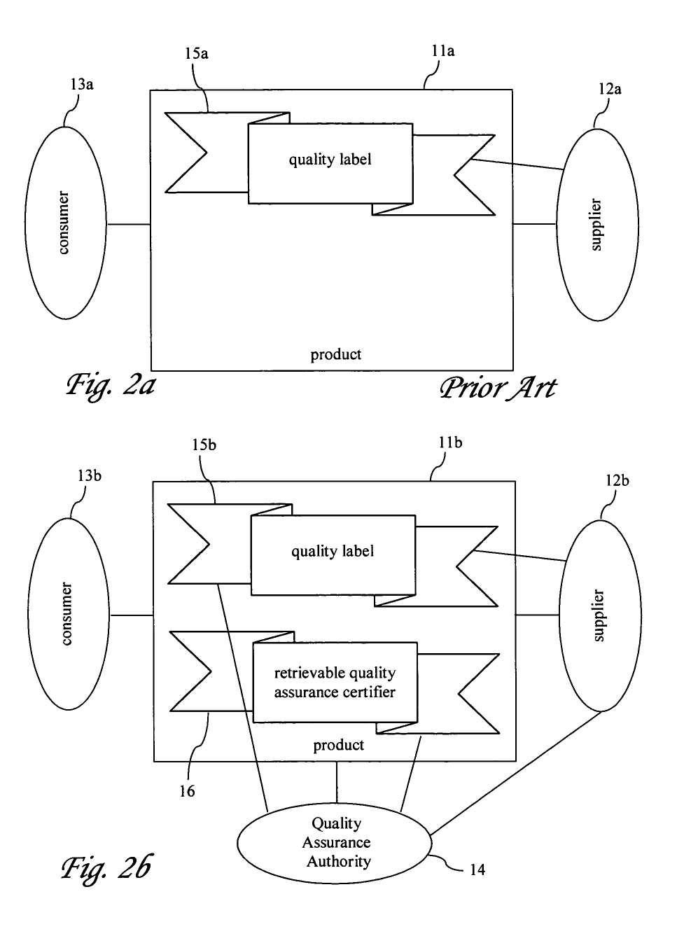

Reference is thus made now to FIG. 2a, presenting a schematic generalized illustration of the prior art, wherein a system comprising at least one product (11a) characterized by a first quality label (15a); at least one supplier (12a) producing said product (11a); at least one consumer (13a) purchasing said product (11a) relying upon said first quality label (15a). Reference is made now to FIG. 2b, presenting a schematic generalized illustration of one embodiment of the present invention, wherein a system comprising at least one product (11b) characterized by a quality label (15b); at least one supplier (12b) producing said product (11b); at least one consumer (13b) purchasing said product (11b) relying upon said quality label (15b); an independent Quality Assurance Authority (14) adapted to provide the said product with a retrievable quality assurance certifying means (16); wherein said certifying means (16) certifies the first quality label (15b) as to indicate that the product (11b) is found in compliance with said quality label (15b) by the Quality Assurance Authority (14).

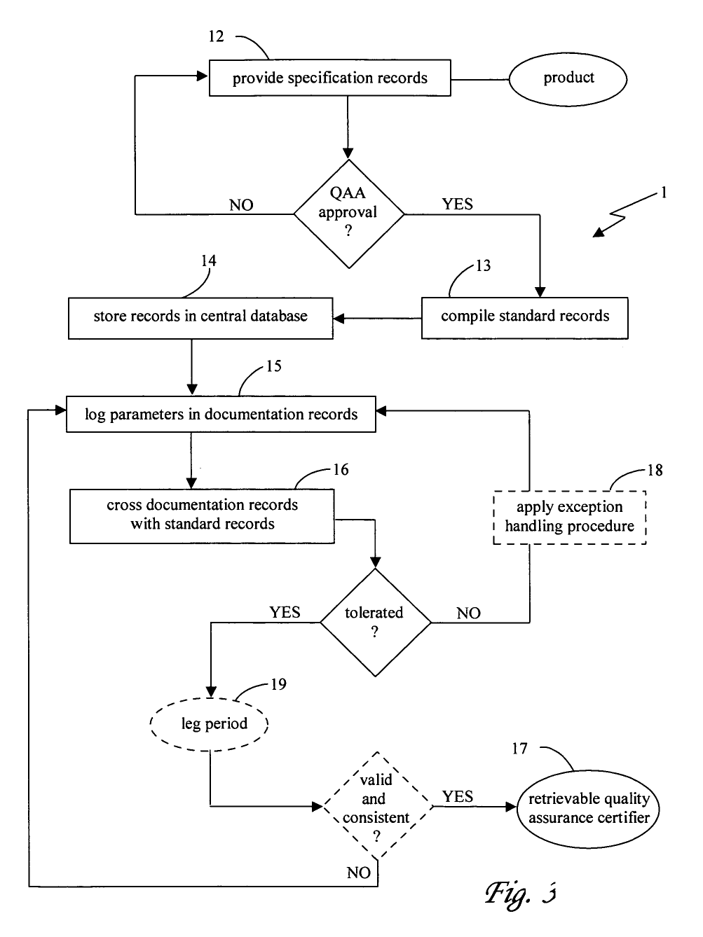

Reference is made now to FIG. 3, presenting a flow chart (10) schematically illustrating a generalization of a method for applying a retrievable quality assurance certifying means for products in accordance with the present invention: a plurality of specification records adapted to characterize said product's quality profile are provided (120) by means of at least one originator commercializing said product; a commercially independent Quality Assurance Authority (QAA) examines these records and upon approval of said specification records, the QAA further compiles a plurality of standard records (130) comprising predetermined parameters adapted to characterize said product's quality standard; each of said parameters is having at least one quality scale including a permitted range and at least one forbidden range, such that quantitative measures of said product's quality are provided; the specification and standard records are then stored in central product quality database (140); a predetermined set of parameters are logged in a plurality of documentation records (150) wherein at least a portion of said parameters is selected from the parameters contained in said standard records; the logged parameters are then crossed with the standard records, and, if all are found tolerated within the product's quality standard by the QAA, the product or the product's package is then associated with a retrievable quality assurance certifying means (170).

Several optional steps in accordance with further embodiments are also introduced, appearing in dashed outline as to indicate that they are either incorporated or omitted in preference, said optional steps include: a leg period (190) in which the step of certifying the product's quality by the QAA is withhold so that the data consisted in said analysis records is validated and found consistent at time; and applying an exception handling procedure (180) wherein one or more parameters that exceed or are below the permitted range according to the product's quality standard are detected. For example, an exception handling procedure consists of one or more of the following actions: alerting the originator, ceasing product distribution, scheduling a second evaluation of the product and/or the parameters wherein the exception occurred, etc.

It is acknowledged that in accordance with the present invention, the association of a product with said retrievable label ensuring said product quality is requested by at least one of the following: said product's originator; a group, organization or trade union of originators; a consumer; a consumers' organization or union; a Quality Assurance Authority or other authorizing entity, including a court, ministry or government; health organization/ministry; agriculture organization/ministry or any combination thereof.

The procedure of the specification records assessment and approval by the QAA, according to one embodiment of the present invention, comprises examining said records from at least one aspect selected in a non-limiting manner from records format; processes involved in production/manufacture; controllability, measurability and availability of different parameters specified in said records; existence of any international or regional standards or regulations relating said product's production/manufacture and/or distribution, and applicability thereof; formulation and detection of failure points; or any combination thereof.

In accordance with yet another embodiment of the invention, the compilation of said standard records is performed either by said product's originator (subject to the QAA's approval); by the QAA according to a product's specification records and/or attributes provided; or by both the originator and the QAA, wherein the QAA withholds its approval until certain requirements are fulfilled, as detailed hereinafter. The final product quality standard obtained is thus based either on existing international or regional standards, e.g. European, US, or Codex Elementarius standards, public health regulations, or on standards devised by the QAA, optionally based on lab experience and/or other techniques or skills, and, optionally, in cooperation with said product's originator.

It is yet in accordance with another embodiment of the invention wherein upon completion of the standard records compilation step, the originator is provided with a set of rules and/or guidelines, instructing said originator concerning each or at least a portion of either the production, manufacture, preparation, packaging, shipment or storage appropriate practices, in accordance with said product's quality standard obtained.

It is yet according to a further embodiment of the present invention to provide the originator with guidelines, directions or directives concerning the information required to the QAA for said quality assurance establishment, for example, in the form of a questionnaire, a fill-out form or table, etc. As an example, suppose the product being an agricultural produce such as lettuce or other consumable vegetable, the originator being the grower, and the QAA being an authorized agricultural standards institute; the information requested by the QAA is selected from the grower's supplemented details; type of produce; number of plots; size of each plot; type of soil; plots location in relation to other plots being in possession by a third party and sprayed regularly, spraying substance; plots identifier, e.g. name or number; geographic location of the plots; previous crops in said plots, if any; previous spraying policies; or any combination thereof.

According to yet another embodiment, the QAA brings to consideration the competence of either the originator or the QAA to ensure the product's quality, wherein the consideration factors are selected from the originator's production equipment; originator's working staff; controllability, measurability and availability of different parameters involved in the crop production; QAA laboratory resources; originator's credentials and reliability; QAA inspection and control means applicability; or any combination thereof.

It is yet according to another embodiment of the present invention wherein said product is an agricultural produce and the production parameters are selected in a non-limiting manner from date of seeding or planting, planting density; field location, crop history and ownership, relevant field's environmental considerations and history; seed identification; seed quality and treatment; manuring and/or fertilizing parameters; fertilizers sorts, water supply and identification of water sources; weed control, insect control and other diseases management; crops harvesting related parameters; recommended analysis procedures and citation for relevant standards for the same or any combination thereof.

It is yet according to another embodiment of the present invention wherein at least a portion of either the production, manufacture, preparation, packing, shipment, storage or marketing parameters are selected from ingredients, additives and/or raw materials; ingredients' quantities, weight or measures; ingredients' expiry; raw materials expiry, presence of contaminators; water rate; pH levels; sanitation of buildings, facilities, equipment, utensils or personnel; preparation temperatures; critical limits/thresholds; humidity rates; drainage conditions; illumination conditions; Kosher, Halal or other religious considerations; warehousing, distribution and post-distribution procedures; or any combination thereof.

It is yet according to another embodiment of the present invention wherein the steps of storing either of said specification, standard or documentation records in said central product quality database is provided in a communicating means selected in a non-limiting manner from online, offline, real time, wired or wireless means.

The term ‘communicating means’ refers hereinafter to one or more means selected from cellular telephones, satellite telephone, facsimile, either wire-telephone or wireless telephone, beeper, palm pilot, MIRS, VPN and/or any personal computer with means for such phone communication, internet, intranet, cables, satellites etc.

It is in the scope of the present invention wherein the aforesaid method is inter alia comprising the following steps: obtaining a plurality of specification records adapted to characterize said product's quality profile from a plurality of data sources; verifying said source and/or data obtained by said data source; storing said specification records in said central product quality database; compiling a plurality of standard records comprising predetermined parameters adapted to characterize said product's quality standard, by a commercially independent Quality Assurance Authority; each of said parameters is having at least one quality scale including a permitted range and at least one forbidden range, such that quantitative measures of said product's quality are provided; storing said standard records in said central product quality database; logging a predetermined set of parameters obtained from at least one data source in a plurality of product documentation records, wherein at least a portion of said parameters is selected from the parameters contained in said standard records; storing said documentation records in said central product quality database; and, wherein all parameters logged in said documentation records are found tolerated within the product's quality standard as according to said standard records by the Quality Assurance Authority, associating the product or the product's package with a retrievable quality assurance certifying means.

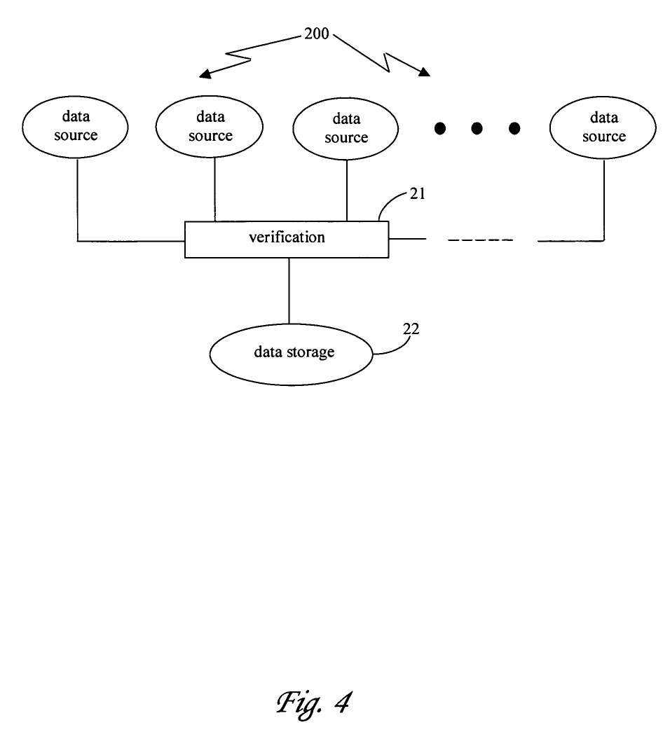

FIG. 4 presents a schematic illustration of the aforesaid steps of data gleaning; data is obtained from a plurality of data sources (200), said sources and/or said data being verified (210) and the data is then stored (220) in said central database.

The term ‘data source’ refers hereinafter to one or more of the following groups of: farmers, growers, breeders, middlemen, manufacturers, pack houses, exporters, logistics providers, importers, distributors, retailers or costumers/consumers.

The term ‘verifying’ refers hereinafter to at least one of the actions selected from source identification; source authentication; data authentication; identity authorization; data verification; identification check; update check; data integrity check; or any combination thereof.

FIG. 4 presents a flow chart (30) schematically illustrating the verification step (210) of FIG. 3, according to one embodiment: upon obtaining data from said data source (310) the source is first being identified (320), an authorization identity check is performed to determine whether said source has been authorized to provide said data, the source is authenticated (330), the data is authenticated (340), an integrity check of the data is performed (360) and the data is being verified (370) and then stored (380) in said central database.

It is in the scope of the present invention wherein the aforesaid data comprising laboratory analytical results; and/or the analysis records comprising data gleaned at any particular point along the supply chain either by the data source or by one or more laboratories, for example, in the field, plot, habitat, packing house, assembly line, shipping craft, marketplace etc.

It is yet according to another embodiment of the present invention wherein the method additionally comprises a predetermined leg period in which the step of providing the quality mark is withhold so that the data source and the data thereof is validated and found consistent at real time. Alternatively or additionally, said method may further comprise the step of signing a predetermined quality agreement.

It is yet in the scope of the present invention wherein said retrievable quality assurance certifying means is selected from label; mark; tag; token; ribbon; flag; patch; seal; wrapper; watermark; printed characters; color code; barcode; magnetic film; magnetic ink; optical card; integrated circuit; digital certificate; electronic chip; RFID tag; photoelectric cell; or any combination thereof.

It is also in the scope of the present invention wherein the association of the product with the said certifying means is provided by means selected from labeling; marking; coloring; patching; printing; embedding; burning; coining; magnetizing; electrifying; laser beaming; photon bombing; invoking an executable digital signing code; or any combination thereof.

It is yet in the scope of the present invention wherein the certifying means further include identification means comprising a unique identifier associated with said product.

It is yet in the scope of the present invention wherein the said identification means are selected from letters; numbers; symbols; signs; alphanumeric characters; any written or graphically drawn notes; animations; texts; visual and/or audio messages; barcodes; optical characters; magnetic imprints; RF signals; or any combination thereof.

According to yet another embodiment of the present invention, the said identifier is further adapted to enable at least one verification action selected from said product's source identification; said product's source authentication; said certifying means' data authentication; said certifying means' issuer authorization check; said certifying means' data integrity check; said certifying means' data verification; said certifying means' update check; said certifying means' validity check; or any combination thereof.

It is also in the scope of the present invention wherein said identifier is associated with a single or group of particular instance or instances of said product.

In accordance with yet another embodiment of the invention, the system further comprises a logical unit coupled to the said central database and adapted for retrieval of each or at least one of said specification, standard or documentation records, and/or any particular type of information or data contained in said records, in accordance with said identification means.

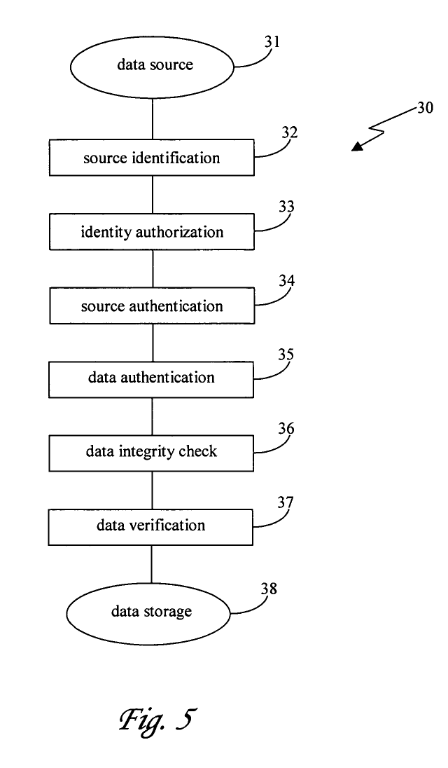

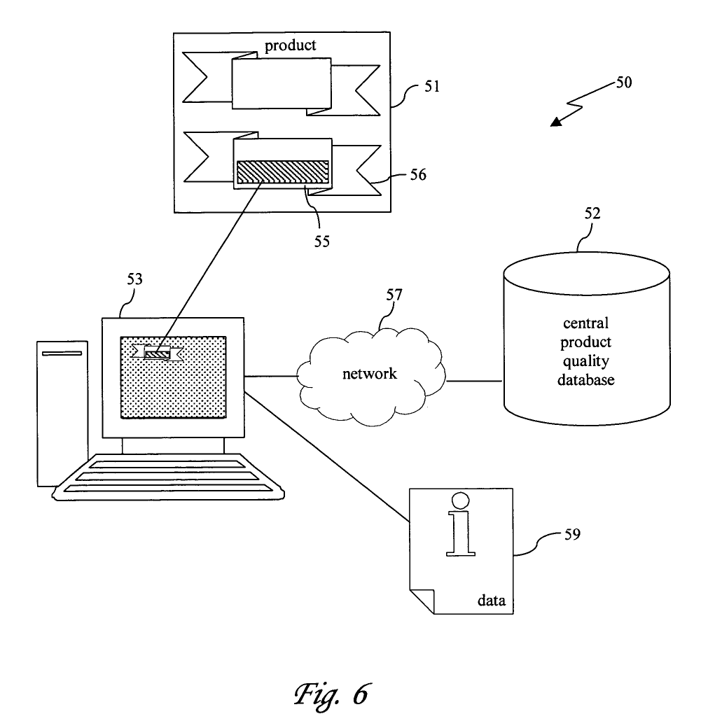

FIG. 5 schematically illustrates an example of said product quality management system (50) wherein said identification means (55) of said product (51) associated with said retrievable quality label (56) are coupled to said label or embedded therein, said identification means are fed, either automatically, wherein said identification means being machine-readable, or manually, into said logical unit (53), e.g. a computer connected to said central database (52) through a communication network (57), resulting in the retrieval of data (59) contained in said central database, specifically, retrieval of each or at least one of said specification, standard or documentation records, and/or any particular type of information or data contained in said records, in accordance with said identification means.

1. A method for applying a retrievable quality assurance certifying means for products, comprising:
a. providing with one or several specification records adapted to characterize said product's quality profile by means of at least one originator commercializing said product;
b. storing said specification records in a central product quality database;
c. compiling a plurality of standard records comprising predetermined parameters adapted to characterize said product's quality standard, by a commercially independent Quality Assurance Authority; each of said parameters is having at least one quality scale including a permitted range and at least one forbidden range, such that quantitative measures of said product's quality are provided;
d. storing said standard records in said central product quality database;
e. logging a predetermined set of parameters in a plurality of documentation records, wherein at least a portion of said parameters is selected from the parameters contained in the said standard records;
f. storing said documentation records in said central product quality database; and,
wherein parameters logged in said documentation records are found tolerated within the product's quality standard as according to said standard records by the Quality Assurance Authority, associating the product or the product's package with retrievable quality assurance certifying means.

2. A method according to claim 1, wherein the parameters logged in said documentation records are selected from product's production parameters; product preparation parameters; product manufacture parameters; product packing parameters; product shipment parameters; product storage parameters; product marketing parameters or any combination thereof.

3. A method according to claim 2, wherein at least a portion of either the production, manufacture, preparation, packing, shipment, storage, distribution or marketing parameters are selected from ingredients, additives and/or raw materials; ingredients' quantities, weight or measures; ingredients' expiry; presence of contaminators; water rate; pH levels; sanitation of buildings, facilities, equipment, utensils or personnel; preparation temperatures; critical thresholds; humidity rates; drainage conditions; illumination conditions; Kosher, Halal or other religious considerations; warehousing, distribution and post-distribution procedures; or any combination thereof.

4. A method according to claim 2, wherein the product is an agricultural produce and the production parameters are selected from date of seeding or planting, planting density; field location, crop history and ownership, relevant field's environmental considerations; seed identification; seed quality and seed treatment; manuring and/or fertilizing parameters; water supply, identification of the water source; weed control, insect control and other diseases management; crops harvesting related parameters; recommended analysis procedures and citation for relevant standards for the same or any combination thereof.

5. A method according to claim 1, further including the step of validating and/or testing at least one of the parameters logged, through a series of one or more laboratory analysis checks.

6. A method according to claim 1, further including the step of applying an exception handling procedure wherein one or more parameters that exceeds or below a permitted range according to the product's quality standard are detected.

7. A method according to claim 1, further including a predetermined leg period during which the step of associating the product or the product's package with a retrievable quality assurance certifying means is withhold until the data contained in said documentation records is validated and found consistent through time.

8. A method according to claim 1, wherein the steps of storing said specification, standard and/or documentation records in said central product quality database are provided by using communicating means selected from online, offline, real time, wired or wireless means.

9. A method according to claim 8, wherein the communicating means are selected from cellular telephones, satellite telephone, facsimile, either wire-telephones or wireless telephone, beeper, palm pilot, MIRS, VPN and/or any personal computer having means for such phone communication, internet, intranet, cables, satellites etc.

10. A method according to claim 1, further including the step of weighing the competence of either the originator or the Quality Assurance Authority to ensure the product's quality.

11. A method according to claim 10, wherein the weighing factors are selected from the originator's production equipment; originator's working staff; location of the originator's production, packaging, shipment or storage facilities; controllability, measurability or availability of different parameters involved in production, packaging, shipment or storage; said Quality Assurance Authority's resources; originator's credentials and reliability; Quality Assurance Authority's inspection and control means applicability; or any combination thereof.

12. A method according to claim 1, comprising inter alia the following steps:
a. obtaining a plurality of specification records adapted to characterize said product's quality profile from a plurality of data sources;
b. verifying said source and/or data obtained by said data source;
c. storing said specification records in said central product quality database;
d. compiling a plurality of standard records comprising predetermined parameters adapted to characterize said product's quality standard, by a commercially independent Quality Assurance Authority; each of said parameters is having at least one quality scale including a permitted range and at least one forbidden range, such that quantitative measures of said product's quality are provided;
e. storing said standard records in said central product quality database;
f. logging a predetermined set of parameters obtained from at least one data source in a plurality of product documentation records, wherein at least a portion of said parameters is selected from the parameters contained in said standard records;
g. storing said documentation records in said central product quality database; and,
wherein all parameters logged in said documentation records are found tolerated within the product's quality standard as according to said standard records by the Quality Assurance Authority, associating the product or the product's package with a retrievable quality assurance certifying means.

13. A method according to claim 12, wherein the data comprising a plurality of laboratory analytical results.

14. A method according to claim 12, wherein said documentation records comprise data gleaned at any particular link along the supply chain either by the data source or by one or more laboratories.

15. A method according to claim 12, further including a predetermined leg period during which the step of associating the product or the product's package with retrievable quality assurance certifying means is withhold so that the data source and the data thereof is validated and found consistent through time.

16. A method according to claim 1, wherein said product is a commodity selected from food; beverages; raw materials; organic compositions; or by-products thereof.

17. A method according to claim 1, wherein said product is a specialty selected from drugs or medications; dietary supplements; vitamins; minerals; amino acids; salts; carbohydrates; proteins; fats; cosmetics; perfumes; soap; chemical preparations; or by-products thereof.

18. A method according to claim 1, wherein the certifying means are selected from label; mark; tag; token; ribbon; flag; patch; seal; wrapper; watermark; printed characters; color code; barcode; magnetic film; magnetic ink; optical card; integrated circuit; digital certificate; electronic chip; RFID tag; photoelectric cell; or any combination thereof.

19. A method according to claim 1, wherein the association of the product with the said certifying means is provided by means selected from labeling; marking; coloring; patching; printing; embedding; burning; coining; magnetizing; electrifying; laser beaming; photon bombing; invoking an executable digital signing code; or any combination thereof.

20. A method according to claim 1, wherein the certifying means further include identification means comprising a unique identifier associated with said product to enable traceability of the product and it's ingredients/production process.

21. A method according to claim 20, wherein the said identification means are selected from letters; numbers; symbols; signs; alphanumeric characters; any written or graphically drawn notes; animations; texts; visual and/or audio messages; barcodes; optical characters; magnetic imprints; RF signals; or any combination thereof.

22. A method according to claim 20, wherein said identifier is further adapted to enable at least one verification action selected from said product's source identification; said product's source authentication; said certifying means' data authentication; said certifying means' issuer authorization check; said certifying means' data integrity check; said certifying means' data verification; said certifying means' update check; said certifying means' validity check; or any combination thereof.

23. A method according to claim 20, wherein said identifier is associated with a single or group of particular instance or instances of said product.

24. A system for applying a retrievable quality assurance certifying means for products, especially useful for product quality management, comprising:
a. at least one product; said product's quality profile is characterized by a plurality of specification records;
b. at least one originator commercializing said product;
c. a commercially independent Quality Assurance Authority adapted for compiling a plurality of standard records comprising predetermined parameters adapted to characterize said product's quality standard; each of said parameters is having at least one quality scale including a permitted range and at least one forbidden range, such that quantitative measures of said product's quality are provided;
d. means for logging a predetermined set of parameters in a plurality of documentation records, wherein at least a portion of said parameters is selected from the parameters contained in said standard records;
e. a central product quality database adapted for storage of said specification, standard or documentation records; and,
f. retrievable quality assurance certifying means, associated with said product or said product's package, wherein all parameters logged in said documentation records are found tolerated within the product's quality standard as according to said standard records by the Quality Assurance Authority.

25. A system according to claim 24, wherein the storage of said specification, standard and/or documentation records in said central product quality database is provided by communicating means selected from online, offline, real time, wired or wireless means.

26. A system according to claim 25, wherein the communicating means are selected from cellular telephones, satellite telephone, facsimile, either wire-telephones or wireless telephone, beeper, palm pilot, MIRS, VPN and/or any personal computer having means for such a phone communication, internet, intranet, cables, satellites etc.

27. A system according to claim 24, wherein said product is a commodity selected from food; beverages; raw materials; organic compositions; or by-products thereof.

28. A system according to claim 24, wherein said product is a specialty selected from drugs or medications; dietary supplements; vitamins; minerals; amino acids; salts; carbohydrates; proteins; fats; cosmetics; perfumes; soaps; chemical preparations; or by-products thereof.

29. A system according to claim 24, wherein the certifying means is selected from label; mark; tag; token; ribbon; flag; patch; seal; wrapper; watermark; printed characters; color code; barcode; magnetic film; magnetic ink; optical card; integrated circuit; digital certificate; electronic chip; RFID tag; photoelectric cell; or any combination thereof.

30. A system according to claim 24, wherein the association of the product with the said certifying means is provided by means selected from labeling; marking; coloring; patching; printing; embedding; burning; coining; magnetizing; electrifying; laser beaming; photon bombing; invoking an executable digital signing code; or any combination thereof.

31. A system according to claim 24, wherein the certifying means further include identification means comprising a unique identifier associated with said product to enable traceability of the product and it's ingredients/production process.

32. A system according to claim 31, wherein the said identification means are selected from letters; numbers; symbols; signs; alphanumeric characters; any written or graphically drawn notes; animations; texts; visual and/or audio messages; barcodes; optical characters; magnetic imprints; RF signals; or any combination thereof.

33. A system according to claim 31, further comprising a logical unit coupled to said database and adapted for retrieval of each or at least one of said specification, standard or documentation records, and/or any particular type of information or data contained in said records, in accordance with said identification means.

34. A system according to claim 31, wherein said identifier is associated with a single or group of particular instance or instances of said product.

35. A product associated with a retrievable quality assurance certifying means, made by a process comprising the steps of:
a. providing with one or several specification records adpated to characterize said product's quality profile by means of at least one originator commercializing said product;
b. storing said specification records in a central product quality database;
c. compiling a plurality of standard records comprising predetermined parameters adapted to characterize said product's quality standard, by a commercially independent Quality Assurance Authority; each of said parameters is having at least one quality scale including a permitted range and at least one forbidden range, such that quantitative measures of said product's quality are provided;
d. storing said standard records in said central product quality database;
e. logging a predetermined set of parameters in a plurality of documentation records, wherein at least a portion of said parameters is selected from the parameters contained in the said standard records;
f. storing said documentation records in said central product quality database; and, wherein all parameters logged in said documentation records are found tolerated within the product's quality standard as according to said standard records by the Quality Assurance Authority, associating the product or the product's package with a retrievable quality assurance certifying means.
